(19) United States
(12) Patent Application Publication
(10) Pub. No.: US 2008/0230967 A1
(43) Pub. Date: Sep. 25, 2008

(54) TELESCOPING SPRING

(75) Inventor: Peter Richard Smullen, Aubrey, TX (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR INC, Bellevue, WA (US)

(21) Appl. No.: 11/689,346

(22) Filed: Mar. 21, 2007

(51) Int. Cl. F16F 1/00

(52) U.S. Cl. 267/74

(57) ABSTRACT

A spring having telescoping capabilities is provided. The spring includes a spring body having an inner diameter and a first spring end that defines a first spring opening. The spring further includes a first elongated member having first and second ends. The first elongated member is slidably received within the spring body such that the first end of the first elongated member is retained within the spring body and the second end of the first elongated member protrudes from the first spring opening.

### BACKGROUND

Conventional heavy duty trucks have a large engine covering hood which tilts about a transverse pivot point located above the bumper to expose the engine for servicing. Although commonly made of lightweight materials, these hoods are nevertheless cumbersome to handle in part because of their heaviness and the relatively long moment arm between the center of gravity of the hood and the pivot axis. For example, the mass of the hood makes arresting its movement toward either the open or closed position a challenge.

A hood tilt assist mechanism is often disposed between the hood and a portion of the vehicle to assist the user when opening or closing the hood. The hood tilt assist mechanism urges the hood into and out of the open or closed position and also slows the hood as it is being moved between positions. The hood tilt assist mechanism normally includes a counterbalancing device to control the movement of the hood. The counterbalancing device may be an extension or compression spring, a cable, a shock-absorber, a gas spring, etc.

In installations where an extension spring is used, often the extension spring includes a hook formed on each end of the spring, as shown in FIG. 1 of the present application. One hook attaches to a portion of the hood and the other hook attaches to a portion of the vehicle. When the hood is moved such that the spring length shortens to less than normal, a hook of the extension spring may become dislodged, the spring may become bent or damaged, or the hook may become mechanically captured in the spring body. When any of the foregoing occur, the utility of the extension spring is hampered or lost.

It is, therefore, desirable in the heavy truck industry to provide an extension spring for a hood tilt assist mechanism that does not suffer from the aforementioned deficiencies stated above.

### SUMMARY

A spring constructed in accordance with one embodiment of the present disclosure is provided. The spring includes a spring body having an inner diameter and a first spring end that defines a first spring opening. The spring further includes a first elongated member having first and second ends. The first elongated member is slidably received within the spring body such that the first end of the first elongated member is retained within the spring body and the second end of the first elongated member protrudes from the first spring opening.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an front view of a representative embodiment of a prior art spring device;

FIG. 2 is an environmental view of a representative embodiment of a telescoping spring suitable for use with a vehicle hood;

FIG. 3 is a side view of the telescoping spring of FIG. 2, wherein the telescoping spring is partially broken away; and

FIG. 4 is a partial side view of the telescoping spring of FIG. 2.

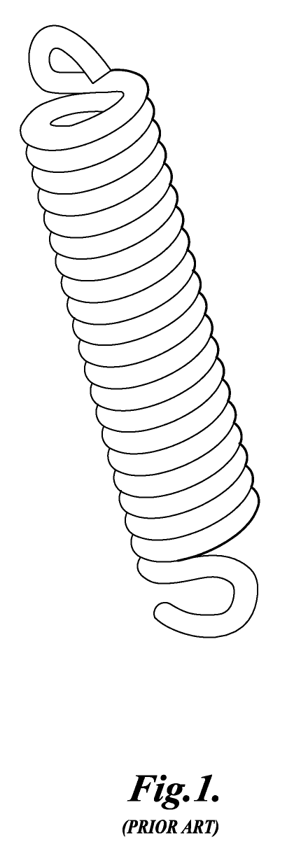

### DETAILED DESCRIPTION

A representative embodiment of a telescoping spring will now be described with reference to the drawings where like numerals correspond to like elements. The present disclosure is directed to a telescoping spring adapted to be used for a hood of a vehicle, such as a heavy duty truck, to assist the user when opening or closing the hood. Although an exemplary embodiment of the telescoping spring will be described hereinafter with reference to vehicle hood assemblies, it will be appreciated that aspects of the telescoping spring have wide application, and may be suitable for use with other mechanical devices, assemblies, systems, etc. Accordingly, the following descriptions and illustrations herein should be considered illustrative in nature, and thus, not limiting the scope of the present disclosure as claimed.

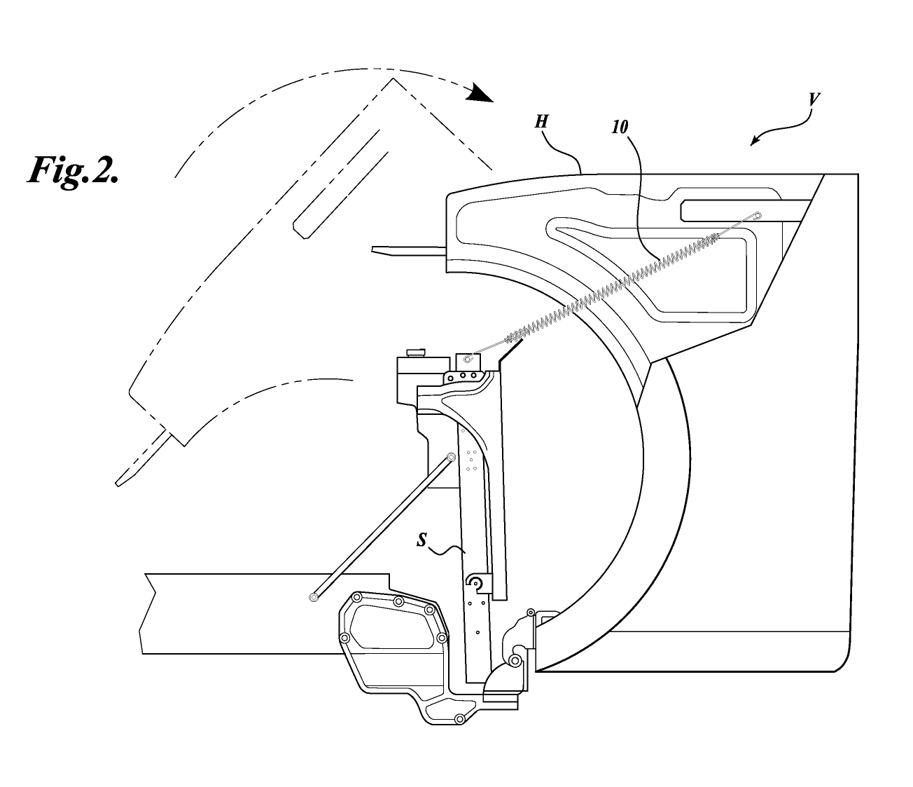

Referring now to FIG. 2, there is shown one representative embodiment of a telescoping spring, generally designated 10, in combination with a vehicle V having a hood H. Preferably, at least one telescoping spring 10 extends between a portion of the hood H and a portion of the vehicle V, such as a radiator support S. The telescoping spring 10 is adapted to urge the hood H into or out of the open or closed position and slow the movement of the hood H as it is moved between positions.

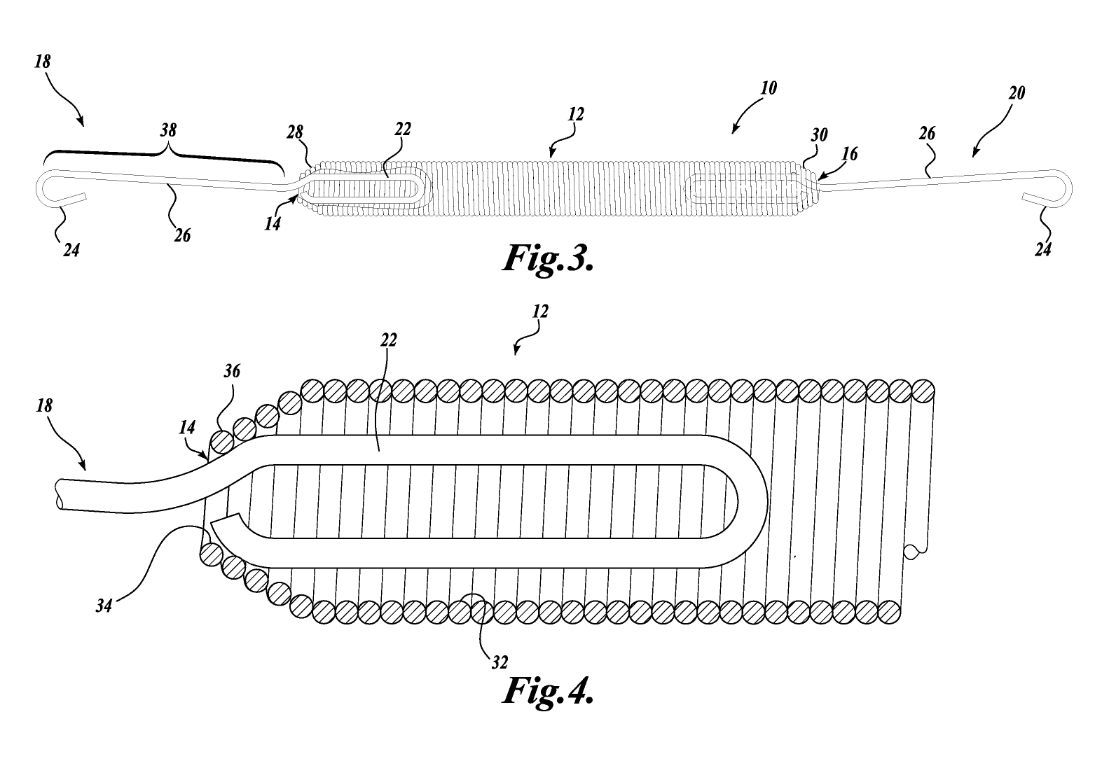

Referring now to FIGS. 3 and 4, the telescoping spring 10 will be described in more detail. As best shown in the embodiments of FIGS. 3 and 4, the telescoping spring 10 includes a helical extension spring body 12 and one or more telescoping members 18 and 20. The spring body 12 is made from any suitable material, such as steel, and having a suitable predetermined spring constant depending on its intended application. The spring body 12 has a first nominal length when fully compressed, as best shown in FIG. 3, and a second nominal length when fully extended (see FIG. 2). The spring body 12 includes first and second conically-tapered ends 28 and 30 that define first and second spring end openings 14 and 16, respectively.

As shown in FIG. 4, the spring body 12 includes a first substantially constant inner diameter that is defined by the inner surface 32 of the coils within the non-tapered portion of the spring body 12. Similarly, the first and second conically-tapered ends 28 and 30 include a tapering inner diameter defined by the inner surface of the coils within the first and second conically-tapered ends 28 and 30. As such, the diameter of the first and second spring openings 14 and 16 are defined by the inner surface 34 of the outermost spring coil loop 36 at the conically-tapered ends 28 and 30.

Referring now to FIGS. 3 and 4, the extension spring 10 further includes first and second elongated telescoping members 18 and 20, portion of which are slidably received within the spring body 12 through the first and second spring end openings 14 and 16, respectively. The telescoping members 18 and 20 each include an enlarged end, such as a loop portion 22, formed at one end of the telescoping member, an attachment portion, such as a hook 24, formed at the other end of the telescoping member, and an elongated portion 26 extending therebetween. The telescoping members 18 and 20 are made from any suitable material, such as steel. In the embodiment shown, the hook 24 of each telescoping member 18 and 20 is configured to secure the telescoping spring 10 between two secure members, such as a portion of the hood H and the radiator support S (see FIG. 2).

The first telescoping member 18 is received within the first opening 14 such that the loop portion 22 and at least part of the elongated portion 26 is disposed within the spring body 12. Similarly, the second telescoping member 20 is received within the second opening 16 such that the loop portion 22 and at least part of the elongated portion 26 is disposed within the spring body 12.

The loop portions 22 of the first and second telescoping members 18 and 20 are wider than the first or second spring end openings 14 and 16, but narrower than the first inner diameter of the spring body 12. In this manner, the loop portion 22 is slidably retained within the spring body 12. In other words, the loop portion 22 may slide within the spring body 12, but the outermost coil loop 36 of the first and second conically-tapered ends 28 and 30 prevent the separation of the loop portions 22 from the spring body 12. When the telescoping members 18 and 20 are pulled outwardly from the spring body 12, the loop portions 22 abut at least the outermost spring coil loops 36 of the ends 28 and 30, respectively. When pulled outwardly from the spring body 12, the elongated portion 26 and the hook 24 of each telescoping member 18 and 20 extends outwardly from the spring body 12 to define an extension portion 38.

In use, the telescoping members 18 and 20 provide the telescoping spring 10 with a greater range of movement. When the extension spring body 12 is fully compressed and the spring body 12 is at its first nominal length (as shown in FIG. 3), the telescoping members 18 and 20 slide axially inside the spring body 12 to shorten the overall length of the telescoping spring 10. If the telescoping members 18 and 20 were not slidable within the spring body 12, the spring 10 would shorten only to a length equal to the first nominal length of the spring body 12 plus the length of the extension portion 38 of the telescoping members 18 and 20. However, the telescoping members 18 and 20 can slide within the spring body 12 to shorten the overall spring length to less than the combined length of the compressed spring body 12 (or first nominal length) and the extension portion 38 of the telescoping members 18 and 20. In this manner, several advantages are realized, for example, the hook 24 will not separate from the hood H or the radiator support S or be mechanically captured in the spring body 12, nor will the spring body 12 be damaged or bent.

As the telescoping spring 10 is extended, the telescoping members 18 and 20 are pulled outwardly from the spring body 12 until the loop portion 22 abuts the outermost spring coil loop 36 of the conically-tapered ends 28 and 30. At this time, continual movement of the telescoping members 18 and 20 extend the spring body 12 from its compressed state to the extended state (see FIG. 2). With the spring body 12 fully extended to its second nominal length and the telescoping members 18 and 20 are pulled outwardly from the spring body 12, the overall length of the telescoping spring 10 is substantially equal to the combined length of the extension portion 38 of the telescoping members 18 and 20 and the second nominal length of the spring body 12.

It will be appreciated that the elongated portion 26 of each telescoping member 18 and 20 is sufficiently long such that the telescoping spring 10 may substantially shorten in length when compressed and substantially increase in length when extended, thereby increasing the overall range of movement of the spring.

Returning now to FIG. 2, one suitable use of the telescoping spring 10 will be generally described. As shown, the telescoping spring 10 in use urges the hood B into or out of the open or closed position and slows the movement of the hood when being moved between positions. The telescoping spring 10 is positioned between the hood H and the radiator support S in any appropriate location and orientation such that it extends when the hood H is either opened or closed, and it compresses when the hood H is positioned substantially between the open and closed position. In one embodiment, the spring body 12 and telescoping members 18 and 20 are of a length such that the spring body 12 fully compresses to its first nominal length when the hood H is positioned substantially between the open and closed position. In this embodiment, if the hood H and radiator support S further exert a compressive load on the spring 10, the telescoping members 18 and 20 slide within the spring body 12 to further shorten the telescoping spring 10, thereby preventing damage to the spring 10 or dislodgement from the hood H or radiator support S.

While illustrative embodiments have been illustrated and described, it will be appreciated that various changes can be made therein without departing from the spirit and scope of the present disclosure.

The embodiments of the invention in which an exclusive property or privilege is claimed are defined as follows:

1. A spring, comprising:
(a) a spring body having an inner diameter and a first spring end that defines a first spring opening;
(b) a first elongated member having first and second ends, the first elongated member being slidably received within the spring body such that the first end of the first elongated member is retained within the spring body and the second end of the first elongated member protrudes from the first spring opening.

2. The spring of claim 1, wherein an attachment portion is formed at the first end of the first elongated member and an enlarged portion is formed at the second end of the first elongated member.

3. The spring of claim 2, wherein the enlarged portion of the first elongated member is wider than the first spring opening and narrower than the inner diameter of the spring body.

4. The spring of claim 1, wherein the spring body includes a second spring end that defines a second spring opening.

5. The spring of claim 4, further comprising a second elongated member having first and second ends, the second elongated member slidably received within the spring such that the first end of the second elongated member is retained within the spring and the second end of the second elongated member protrudes from the second spring opening.

6. The spring of claim 5, wherein an attachment portion is formed at the first end of the second elongated member and an enlarged portion is formed at the second end of the second elongated member.

7. The spring of claim 6, wherein the enlarged portion of the second elongated member is wider than the second spring opening and narrower than the inner diameter of the spring body.

8. A spring, comprising:
(a) a spring body having an inner diameter and a first spring end that defines a first spring opening, wherein the spring body has a first nominal length when fully compressed;
(b) a first elongated member having an enlarged portion and an extension portion, the first elongated member slidably received within the spring such that the enlarged portion is retained within the spring and at least part of the extension portion protrudes from the first spring opening, wherein the first elongated member is slidable within the spring body to shorten the spring to less than the combined length of the first nominal length of the spring body and the extension portion of the first elongated member.

9. The spring of claim 8, wherein an attachment portion is formed on the extension portion of the first elongated member.

10. The spring of claim 8, wherein the enlarged portion of the first elongated member is wider than the first spring opening and narrower than the inner diameter of the spring body.

11. The spring of claim 8, wherein the spring body includes a second spring end that defines a second spring opening.

12. The spring of claim 11, further comprising a second elongated member having an enlarged portion and an extension portion, the second elongated member slidably received within the spring such that the enlarged portion is retained within the spring and at least part of the extension portion protrudes from the second spring opening, wherein the second elongated member is slidable within the spring to shorten the spring to less than the combined length of the first nominal length of the spring body and the extension portions of the first and second elongated members.

13. The spring of claim 12, wherein an attachment portion is formed on the extension portion of the second elongated member.

14. The spring of claim 12, wherein the enlarged portion of the second elongated member is wider than the second spring opening and narrower than the inner diameter of the spring body.
